(19) United States
(12) Patent Application Publication
(10) Pub. No.: US 2018/0366953 A1
(43) Pub. Date: Dec. 20, 2018

(54) ENERGY MANAGEMENT SYSTEM

(71) Applicant: Carrier Corporation, Paim Beach Gardens, FL (US)

(72) Inventors: Luciano DeTommasi, Cork (IE); Konstantinos Kouramas, Cork (IE); Marcin Cychowski, Cork (IE); Emile Simon, Cork (IE)

(21) Appl. No.: 15/781,308

(22) PCT Filed: Dec. 2, 2016
(86) PCT No.: PCT/US2016/064543

§ 371 Date: Jun. 4, 2018

Related U.S. Application Data
(60) Provisional application No. 62/263,146, filed on Dec. 4, 2015.

(51) Int. Cl. H02J 3/38; H02J 3/14; G06Q 50/06

(52) U.S. Cl. CPC H02J 3/383; H02J 3/386; H02J 2003/003; G06Q 50/06; H02J 3/14

(57) ABSTRACT

An energy distribution system includes at least one electric energy load and at least one thermal energy load. A grid of the system selectively supplies electric energy in accordance with a grid tariff profile. The energy distribution system further includes electric and thermal energy sources along with an energy management system that includes a computer processor and a computer readable storage media configured to forecast thermal and electrical energy loads, forecast electric energy generation capability of the electric energy source, forecast thermal energy generation capability of the thermal energy source, and perform an analysis based on energy availability and cost to meet the thermal and electrical energy load forecasts.

### BACKGROUND

The present disclosure relates to an energy management system and, more particularly, to an energy management system for managing the distribution of electric and thermal energy.

Energy distribution systems may generally serve pre-specified geographic areas or districts. Such systems are generally divided between electric and thermal energy systems. Electric energy systems may entail micro-grid electrical equipment, and thermal energy systems may include heating ventilation and cooling (HVAC) systems or other types of heating systems. Both electrical and thermal energy systems are controlled and optimized separately.

### SUMMARY

An energy distribution system according to one, non-limiting, embodiment of the present disclosure includes at least one electric energy load; at least one thermal energy load; a grid for selectively supplying electric energy associated with a grid tariff profile; an electric energy source; a thermal energy source; and an energy management system including a computer processor and a computer readable storage media, the energy management system configured to forecast thermal and electrical energy loads, forecast electric energy generation capability of the electric energy source, forecast thermal energy generation capability of the thermal energy source, and perform an analysis based on energy availability and cost to meet the thermal and electrical energy load forecasts.

Additionally to the foregoing embodiment, the electric energy source comprises a renewable electric energy source.

In the alternative or additionally thereto, in the foregoing embodiment, the thermal energy source comprises a boiler.

In the alternative or additionally thereto, in the foregoing embodiment, the electric energy source comprises an electric energy storage unit.

In the alternative or additionally thereto, in the foregoing embodiment, the renewable electric energy source comprises wind power and the electric energy storage unit comprises a battery.

In the alternative or additionally thereto, in the foregoing embodiment, the renewable electric energy source is configured to generate electric energy selectively routed to the at least one electric energy load and the electric energy storage unit as dictated by the energy management system.

In the alternative or additionally thereto, in the foregoing embodiment, the energy distribution system includes a combustion engine; and a generator coupled to the combustion engine for selectively generating an electric energy supply.

In the alternative or additionally thereto, in the foregoing embodiment, the energy distribution system includes a heat exchanger operatively associated with the combustion engine for selectively generating thermal energy.

In the alternative or additionally thereto, in the foregoing embodiment, the thermal energy is selectively routed to the at least one thermal energy load.

In the alternative or additionally thereto, in the foregoing embodiment, the at least one thermal energy load is configured to receive thermal energy from the heat exchanger and the thermal energy source as dictated by the energy management system.

In the alternative or additionally thereto, in the foregoing embodiment, the thermal energy source comprises a boiler.

In the alternative or additionally thereto, in the foregoing embodiment, the thermal energy source comprises a renewable thermal energy source.

In the alternative or additionally thereto, in the foregoing embodiment, the energy distribution system includes a first sub-tiered energy distribution system associated with a first district and including the at least one electric energy load, the at least one thermal energy load, the grid for selectively supplying electric energy associated with a grid tariff profile, the electric energy source, the thermal energy source, and the energy management system; a second sub-tiered energy distribution system associated with a second district and including a second at least one electric energy load, a second at least one thermal energy load, a second grid for selectively supplying electric energy associated with a second grid tariff profile, a second electric energy source, a second thermal energy source, and a second energy management system; and a multi-district integration module configured to control the transfer of energy between the first and second districts based on availability and cost.

A method of operating an energy management system according to another, non-limiting, embodiment includes generating an electric and thermal load forecast; establishing an electric and thermal energy generation forecast based on at least one electric and thermal energy source; noting an energy storage unit initial state; noting a grid tariff profile based on a public utility grid; utilizing the electric and thermal load forecasts, the electric and thermal energy generation forecast, the energy storage unit initial state, and the grid tariff profile to determine micro-grid and heating system set-points by an optimization module to minimize energy cost; and applying set-points to at least one of the at least one electric energy source and the at least one thermal energy source.

Additionally to the foregoing embodiment, the at least one electric energy source comprises a renewable electric energy source.

In the alternative or additionally thereto, in the foregoing embodiment, the at least one electric energy source comprises a generator coupled to a combustion engine.

In the alternative or additionally thereto, in the foregoing embodiment, the at least one thermal energy source comprises a boiler.

In the alternative or additionally thereto, in the foregoing embodiment, the energy storage unit comprises an electric energy storage unit.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a schematic of an energy distribution system according to one, non-limiting, exemplary embodiment of the present disclosure;

FIG. 2 is a flow chart detailing an energy management system of the energy distribution system;

FIG. 3 is a graph illustrating an electrical load profile and electric generating source profiles;

FIG. 4 is a graph illustrating a thermal load profile and thermal generating source profiles;

FIG. 5 is a schematic of the energy distribution system applied to a multi-district application; and

FIG. 6 is a flow chart of a method of operating the energy management system.

### DETAILED DESCRIPTION

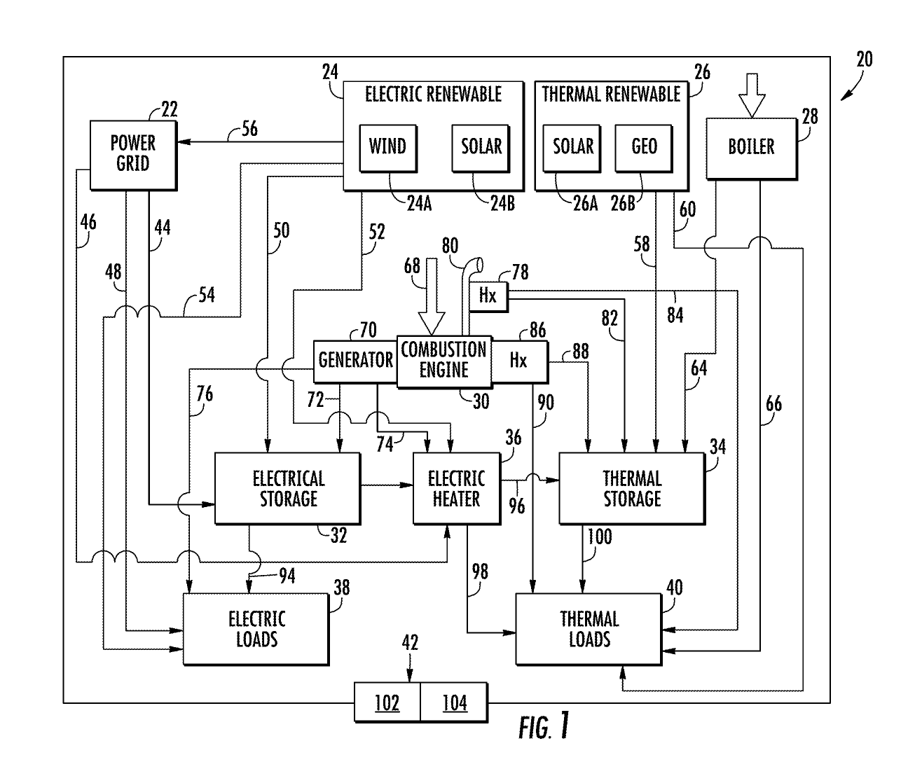

Referring to FIG. 1, an energy distribution system 20 is illustrated with the capability to manage both electrical and thermal energy demands of at least one district. Examples of a district may include a neighborhood, a high-rise, a ship, or any other entity that is a pre-planned participant of the energy distribution system 20. The energy distribution system 20 may include a public power grid 22, a renewable electric energy source 24, a renewable thermal energy source 26, a thermal energy source 28 (e.g., boiler), an electric and/or thermal energy source 30 (e.g., combustion engine), an electric energy source 32 (e.g., electric energy storage unit), a thermal energy source 34 (e.g., thermal energy storage unit 34), a thermal energy source 36 (e.g., electric heater), various electric energy loads 38, various thermal energy loads 40, and an energy management system 42 configured to distribute the energy according to a pre-defined set of parameters.

The public power grid 22 may be adapted to selectively provide electric energy to the electric energy storage unit 30 over an electric conductor 44, to the electric heater 36 over an electric conductor 46, and to the electric loads 38 over electric conductor 48. Similarly, the renewable electric energy source 24 may be adapted to selectively provide electric energy to the electric energy storage unit 30 over an electric conductor 50, to the electric heater 36 over an electric conductor 52, and to the electric loads 38 over electric conductor 54. The renewable electric energy source 24 may also be configured to provide and sell electric energy back to the public power grid 22 via electric conductor 56. Non-limiting examples of renewable electric energy sources may include a wind power unit 24A and/or a solar power unit 24B.

The renewable thermal energy source 26 of the energy distribution system 20 may be adapted to selectively provide thermal energy, via (for example) a heat transfer fluid, to the thermal energy storage unit 34 through a conduit 58, and to the thermal loads 40 through a conduit 60. Non-limiting examples of renewable thermal energy sources may include a solar heating unit 26A and a geothermal unit 26B.

The boiler unit 28 of the energy distribution system 20 may be adapted to heat a heat transfer fluid (e.g., hot water, steam, etc.) utilizing a fossil fuel (see arrow 62). The boiler unit 28 may be adapted to selectively provide thermal energy, via the heat transfer fluid, to the thermal energy storage unit 34 through a conduit 64, and to the thermal loads 40 through a conduit 66. The boiler unit 28 and conduits 64, 66 may be any type of configuration including open loop where thermal energy is provided directly to the thermal energy storage unit 34 and/or the thermal energy loads 40, or a closed loop where thermal energy is exchanged, for example, through a heat exchanger (not shown) of the thermal energy storage unit 34 and or thermal loads 40. Examples of fossil fuels may include natural gas, n-heptane liquid gas, diesel fuel, coal and other combustible products.

The combustion engine 30 of the energy distribution system 20 may be any form of a combustion engine including a multi-cylinder engine, a turbine engine, and others. The combustion engine 30 may run on any variety of fuels (see arrow 68). Examples of the fuel 68 may include natural gas, n-heptane liquid gas, diesel fuel, and others. The combustion engine 30 may be adapted to drive an electric generator 70 and thereby selectively provide electric energy to the electric energy storage unit 32 over a conductor 72, to the electric heater 36 over a conductor 74, and to the electric energy loads 38 over a conductor 76.

The combustion engine 30 may emit residual thermal energy in a variety of ways. This thermal energy may be captured and used as part of the energy distribution system 20. For example, an exhaust gas heat exchanger 78 may be integrated into an exhaust 80 of the engine 30, and configured to capture heat emitted from exhaust gases of the combustion engine 30. The heat exchanger 78 may be an exhaust gas-to-air heat exchanger, or may be an exhaust gas-to-liquid heat exchanger. The exhaust gas, via the heat exchanger 78 may transfer thermal energy to a heat transfer fluid that delivers thermal energy to the thermal energy storage unit 34 and/or the thermal energy loads 40. More specifically, the heat transfer fluid may selectively flow through a conduit 82 to deliver thermal energy to the thermal energy storage unit 34, and/or selectively flow through a conduit 84 to delivery thermal energy to the thermal energy loads 40.

As another example of capturing residual thermal energy from the combustion engine 30, a heat exchanger 86 may be integrated into a liquid cooling portion of the engine adapted to generally cool the engine. The heat exchanger 86 may be configured to capture the thermal energy from the cooling liquid. The heat exchanger 78 may thus be a liquid-to-liquid heat exchanger, or may be a liquid-to-air heat exchanger (i.e., radiator). More specifically, the heat transfer fluid (i.e., liquid or air) may selectively flow through a conduit 88 to deliver thermal energy to the thermal energy storage unit 34, and/or selectively flow through a conduit 90 to delivery thermal energy to the thermal energy loads 40.

The electric energy storage unit 32 configured to selectively receive electric energy from the public utility power grid 22, the renewable electric energy source 24, and/or the generator 70 may, as one non-limiting example, be at least one battery. The electric energy storage unit 32 may be adapted to selectively provide electric energy to the electric heater 36 over an electric conductor 92, and to the electric energy loads 38 over an electric conductor 94.

The electric heater 36 may generally be constructed and arranged to produce thermal energy from electric energy. The electric heater 36 may selectively receive the electric energy from the public utility power grid 22, the renewable electric energy source 24, the generator 70 and/or the electric energy storage unit 32. The electric heater 36 may be adapted to, for example, heat a heat transfer fluid, which then selectively flows to the thermal energy storage unit 34 and/or the thermal energy loads 40 through respective conduits 96, 98.

The thermal energy storage unit 34 may, for example, be a tank that may be insulated for holding a heated thermal fluid that may be liquid water. As previously described, the thermal energy storage unit 34 may selectively receive thermal energy from the renewable thermal energy source 26, the boiler 28, the heat exchangers 78, 86 and the electric heater 36. The thermal energy storage unit 34 may be adapted to selectively provide thermal energy (via, for example, a heat transfer fluid) to the thermal energy loads 40 through a conduit 100.

The energy management system 42 is generally comprised of a network of sensors (not shown), measurement devices (not shown), computing devices and an optimization method that minimizes the cost of energy (i.e., including cost of, for example, fossil fuel 68 and the electric energy purchased from the public utility grid 22) given the presence of components that produce, at the same time, electric energy and thermal energy (e.g., heat produced by the burning of natural gas). In addition, the energy management system 42 may factor in the ability to store electric and thermal energy via the electric energy storage unit 32 and the thermal energy storage unit 34 which may be supplied energy when, for example, the cost of the electric energy from the grid 22 is low, the cost of the fossil fuel 68 is low, and/or the electric and thermal energy produced by the renewable electric and thermal energy sources 24, 26 is plentiful. Additional equipment (not shown) may be electric pumps used to circulate, for example, hot water heated by the boiler 28, and/or combustion engine 30. Influencing factors of all the equipment may be the amount of electrical and thermal power needed by the district during a predetermined time period to supply the loads and ensure the thermal comfort of any occupants in the district. It is further contemplated that in situations where the public utility grid 22 and/or the fossil fuel 68 becomes unavailable, other components of the energy distribution system 20 may re-align via the energy management system 42 to cost effectively provided energy to the electric energy loads 38 and/or the thermal energy loads 40.

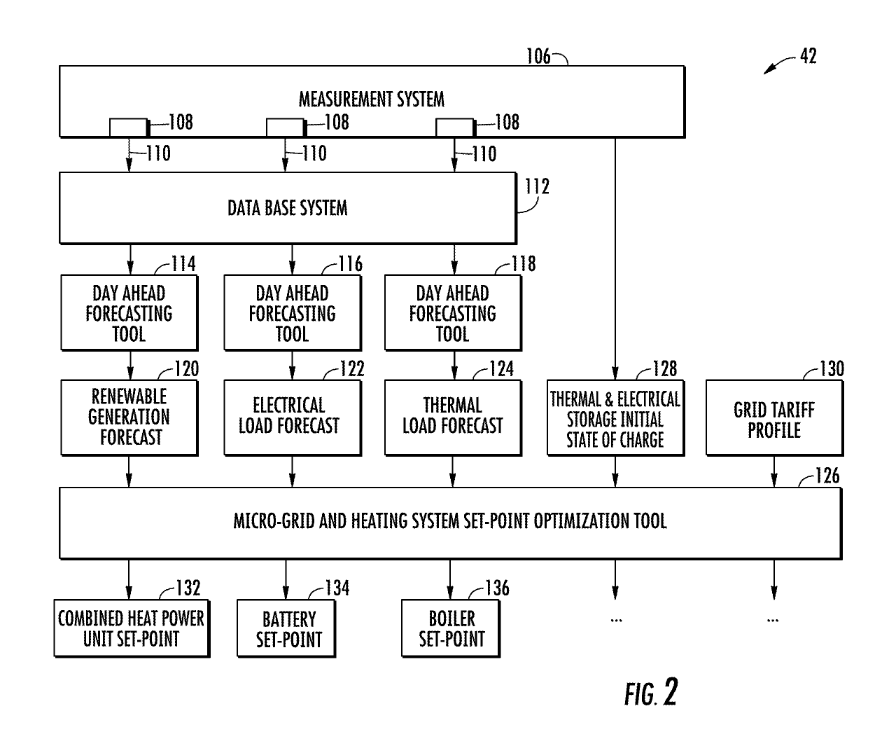

The energy management system 42 may include a computer processor 102 (e.g., microprocessor) and a computer readable storage media 104 for loading and executing software-based programs and/or algorithms. Referring to FIG. 2, the system 42 may include a measurement system 106 that includes various devices 108 (e.g., sensors) strategically located to measure the electric and thermal energy being delivered across the various conductors and conduits previously described. Device output signals 110 may be sent to a data-base system 112 integrated as part of the computer readable storage media 104. The data base system 112 may store and process the output signals 110 and various forecasting tools or modules, that may be software-based, uses this data to forecast required energy needs. More specifically, the forecasting modules may include a renewable generation forecast module 114 (i.e., may be divided between the renewable electric and thermal energy sources), an electrical load forecast module 116, and a thermal load forecast module 118. The actual forecasting may be performed over a predetermined period of time. The renewable generation forecast module 114 may use previously recorded data to forecast the renewable electric and/or thermal energy that the respective sources 24, 26 may be capable of producing, and thus outputs a renewable generation forecast 120. The electrical and thermal load modules 116, 118 may use previously recorded data to determine forecasted needs of the respective electric and thermal energy loads 38, 40, and thus outputs respective electrical and thermal load forecasts 122, 124.

The energy management system 42 may further include a micro-grid and heating system set-point optimization tool or module 126 that may be software-based. The module 126 may include an algorithm executed by the computer processor 102. The algorithm may utilize input data such as the renewable generation forecast 120, the electrical load forecast 122, the thermal load forecast 124, thermal and electrical storage initial state of charge 128 and a grid tariff profile 130 to calculate and output a series of set-points. The variety of set-points is dependent upon the variety of components included in the energy distribution system 20. For example, the set-point data may include a combined heat power unit set-point 132, an electric energy storage unit set-point 134 associated with the electric energy storage unit 32, a boiler set-point 136 associated with the boiler 28, and other set-points. The various set-points 132, 134, 136 may further be utilized by the optimization module 126 to optimize a sequence of electric energy and/or thermal energy transfers to meet the needs of the energy distribution system 20 in a reliable and cost effective manner.

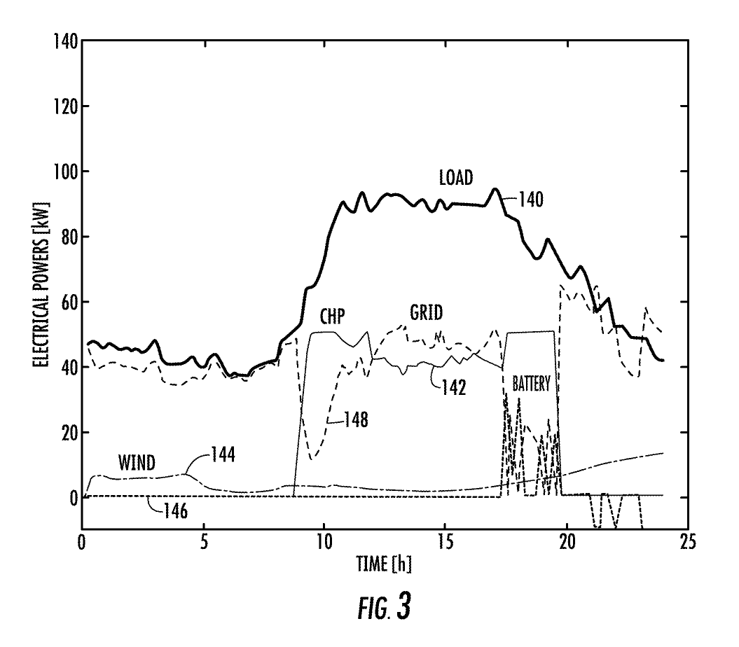

Referring to FIG. 3, an example of an electrical energy distribution forecast is illustrated over a period of time. In this illustration, the period of time is about 25 hours. The various lines represent an electrical load forecast distribution 140 associated with the electrical load forecast 122, a self-generated electric energy supply forecast distribution 142 associated with the electrical load forecast 122 and the generator 70, a renewable electric energy supply forecast distribution 144 associated with the renewable generation forecast 120, a stored electric energy supply forecast distribution 146 associated with the electrical storage initial state of charge 128 and the electric energy storage unit 32, and a grid supply forecast distribution 148 associated with the grid tariff profile 130 and the public utility grid 22. As illustrated, the summation of the electric energy supply distributions 142, 144, 146, 148 is substantially equivalent to the electrical load forecast distribution 140 during any given moment in time.

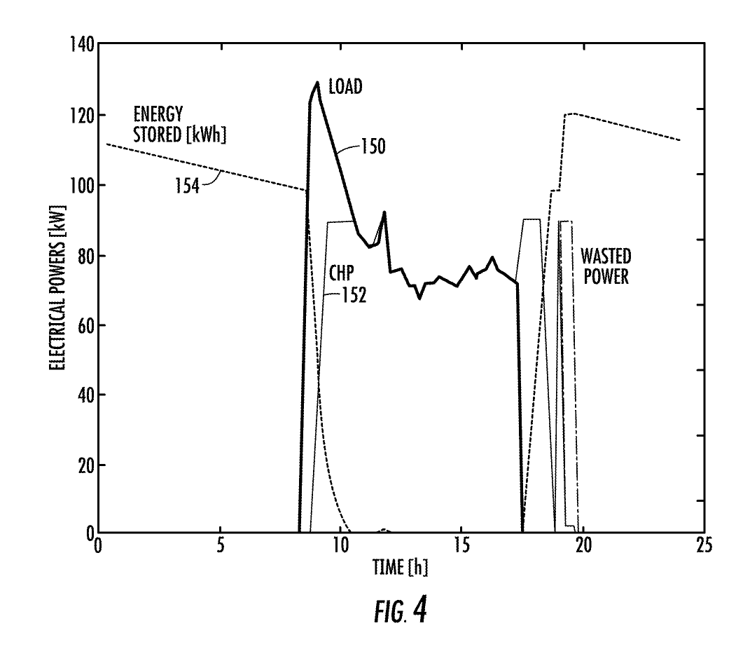

Referring to FIG. 4, an example of a thermal energy distribution forecast is illustrated over a period of time. In this illustration, the period of time is about 25 hours. The various lines represent a thermal load forecast distribution 150 associated with the thermal load forecast 124 and the thermal energy loads 40, a self-generated thermal energy supply distribution 152 that may be associated (as one example) with the combustion engine 30 and heat exchangers 78, 86, and a stored thermal energy supply forecast distribution 154 associated with the thermal and electrical storage initial state of charge 128 and the thermal energy storage unit 34. As illustrated, the summation of the thermal energy supply distributions 152, 154 is substantially equivalent to the thermal load forecast distribution 150 during any given moment in time

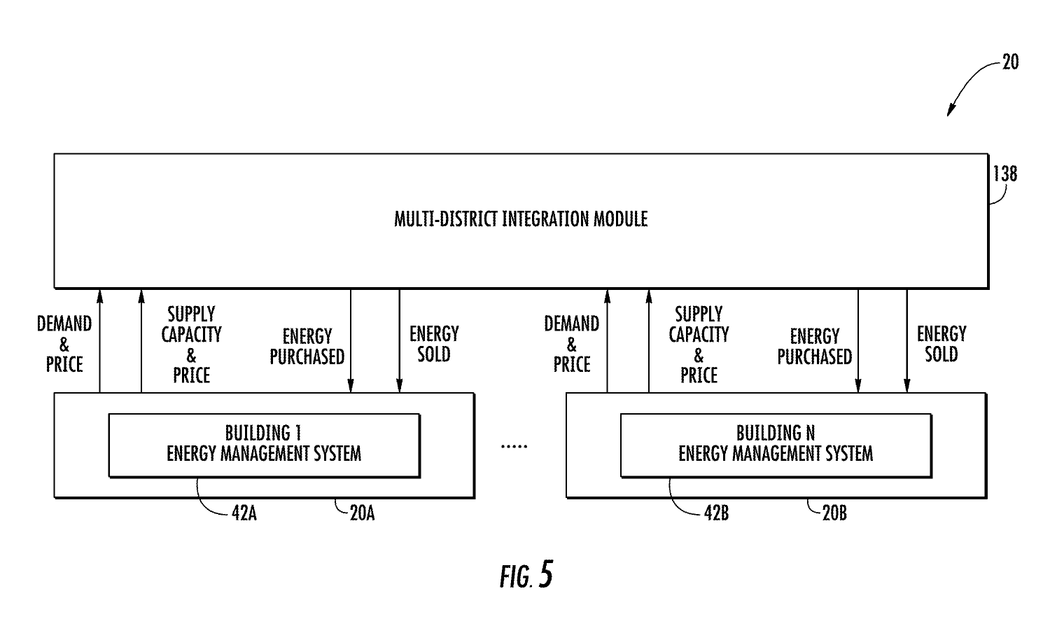

Referring to FIG. 5, the energy distribution system 20 may be applied to multiple districts with each district having a sub-tiered energy distribution system 20A, 20B with each sub-tiered energy distribution system 20A, 20B having a respective, sub-tiered, energy management system 42A, 42B. The sub-tiered energy distribution systems 20A, 20B may be integrated such that they generally communicate with one-another through a multi-district integration module 138 that may generally be part of the processor 102 and computer readable storage media 104.

The hierarchical optimization-based energy management framework minimizes multiple energy bills within a multi-district application. The energy exchanged between different districts (i.e., purchased/sold within the multi-districts) may be determined by the integration module 138. The individual districts, or sub-tiered level may solve the energy management optimization issues specific to the district, thus minimizing energy cost for each specific district, while accounting for additional constraints dictated by the energy exchange between districts.

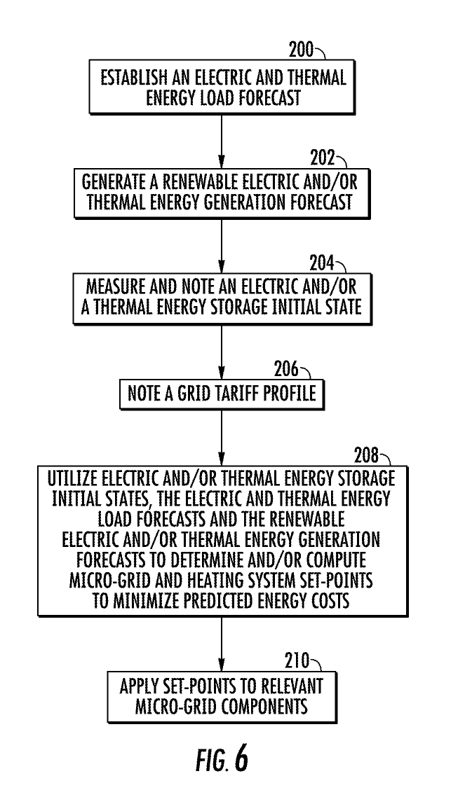

Referring to FIG. 6, a method of operating the energy distribution system 20 includes the step 200 of establishing both an electric and thermal energy load forecast 122, 124 for a period of time. As step 202 at least one of a renewable electric energy generation forecast 120 and/or a renewable thermal energy generation forecast 120 is generated. As step 204, a thermal energy storage initial state and or an electric energy storage initial state of charge 128 is noted. As step 206, a grid tariff profile is noted. In a step 208, the micro-grid and thermal load set-point optimization module 126 determines or computes micro-grid and heating system set-points utilizing the electric and/or thermal energy storage initial states, the electric and thermal energy load forecasts, and the renewable electric and/or thermal energy generation forecasts, thereby minimizing predicted energy costs. As step 210 and based on this computation, the optimization module 126 applies the set-points to relevant electric and thermal energy generation components necessary to meet the forecasted energy demands.

While the present disclosure is described with reference to exemplary embodiments, it will be understood by those skilled in the art that various changes may be made and equivalents may be substituted without departing from the scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

What is claimed is:

1. An energy distribution system comprising:
at least one electric energy load;
at least one thermal energy load;
a grid for selectively supplying electric energy associated with a grid tariff profile;
an electric energy source;
a thermal energy source; and
an energy management system including a computer processor and a computer readable storage media, the energy management system configured to forecast thermal and electrical energy loads, forecast electric energy generation capability of the electric energy source, forecast thermal energy generation capability of the thermal energy source, and perform an analysis based on energy availability and cost to meet the thermal and electrical energy load forecasts.

2. The energy distribution system set forth in claim 1, wherein the electric energy source comprises a renewable electric energy source.

3. The energy distribution system set forth in claim 1, wherein the thermal energy source comprises a boiler.

4. The energy distribution system set forth in claim 2, wherein the electric energy source comprises an electric energy storage unit.

5. The energy distribution system set forth in claim 4, wherein the renewable electric energy source comprises wind power and the electric energy storage unit comprises a battery.

6. The energy distribution system set forth in claim 5, wherein the renewable electric energy source is configured to generate electric energy selectively routed to the at least one electric energy load and the electric energy storage unit as dictated by the energy management system.

7. The energy distribution system set forth in claim 1 further comprising:
a combustion engine; and
a generator coupled to the combustion engine for selectively generating an electric energy supply.

8. The energy distribution system set forth in claim 7 further comprising:
a heat exchanger operatively associated with the combustion engine for selectively generating thermal energy.

9. The energy distribution system set forth in claim 8, wherein the thermal energy is selectively routed to the at least one thermal energy load.

10. The energy distribution system set forth in claim 8, wherein the at least one thermal energy load is configured to receive thermal energy from the heat exchanger and the thermal energy source as dictated by the energy management system.

11. The energy distribution system set forth in claim 10, wherein the thermal energy source comprises a boiler.

12. The energy distribution system set forth in claim 10, wherein the thermal energy source comprises a renewable thermal energy source.

13. The energy distribution system set forth in claim 1 further comprising:
a first sub-tiered energy distribution system associated with a first district and including the at least one electric energy load, the at least one thermal energy load, the grid for selectively supplying electric energy associated with a grid tariff profile, the electric energy source, the thermal energy source, and the energy management system;
a second sub-tiered energy distribution system associated with a second district and including a second at least one electric energy load, a second at least one thermal energy load, a second grid for selectively supplying electric energy associated with a second grid tariff profile, a second electric energy source, a second thermal energy source, and a second energy management system; and
a multi-district integration module configured to control the transfer of energy between the first and second districts based on availability and cost.

14. A method of operating an energy management system comprising:
generating an electric and thermal load forecast;
establishing an electric and thermal energy generation forecast based on at least one electric and thermal energy source;
noting an energy storage unit initial state;
noting a grid tariff profile based on a public utility grid;
utilizing the electric and thermal load forecasts, the electric and thermal energy generation forecast, the energy storage unit initial state, and the grid tariff profile to determine micro-grid and heating system set-points by an optimization module to minimize energy cost; and
applying set-points to at least one of the at least one electric energy source and the at least one thermal energy source.

15. The method set forth in claim 14, wherein the at least one electric energy source comprises a renewable electric energy source.

16. The method set forth in claim 15, wherein the at least one electric energy source comprises a generator coupled to a combustion engine.

17. The method set forth in claim 16, wherein the at least one thermal energy source comprises a boiler.

18. The method set forth in claim 16, wherein the energy storage unit comprises an electric energy storage unit.
